(19) United States
(12) Patent Application Publication
(10) Pub. No.: US 2017/0116004 A1
(43) Pub. Date: Apr. 27, 2017

(54) DYNAMIC DETERMINATION OF THE APPLICABILITY OF A HARDWARE ACCELERATOR TO A REQUEST

(71) Applicant: International Business Machines Corporation, Armonk, NY (US)

(72) Inventors: Amar Devegowda, Bangalore (IN); Frank Haverkamp, Tuebingen (DE); Marcel Mitran, Markham (CA); Anthony T. Sofia, Highland, NY (US)

(21) Appl. No.: 15/066,075

(22) Filed: Mar. 10, 2016

Related U.S. Application Data
(63) Continuation of application No. 14/923,564, filed on Oct. 27, 2015.

(51) Int. Cl. G06F 9/445; G06F 9/46

(52) U.S. Cl. CPC G06F 9/44505; G06F 9/466

(57) ABSTRACT

A method, system, and computer program product to dynamically determine the applicability of a hardware accelerator to a request for a function, the request including a set of blocks of input data, are described. Aspects include storing a decision of whether to use the hardware accelerator or a software module to execute the function based on a previously processed request and determining whether the request matches the previously processed request. Aspects also include processing the set of blocks of input data using the hardware accelerator or the software module according to the decision based on the request matching the previously processed request.

### DOMESTIC BENEFIT/NATIONAL STAGE INFORMATION

This application is a continuation of U.S. application Ser. No. 14/923,564 filed Oct. 27, 2015, the disclosure of which is incorporated by reference herein in its entirety.

### BACKGROUND

The present invention relates to hardware accelerators, and more specifically, to dynamic determination of the applicability of a hardware accelerator to a request.

In systems that process a set of instructions, hardware accelerators (e.g., field programmable gate array (FPGA), graphics processing unit (GPU)) can be used to offload processor intensive tasks (e.g., compression, decompression, searching, sorting) from the central processing unit (CPU) of the system. Such offloading of processor intensive tasks can result in higher throughput because the tasks are processed faster by the hardware accelerator than in software by the CPU. The decision of whether to use software or a hardware accelerator to perform a given task for which a hardware accelerator is available may be based on the size of the input data. This is because there are overhead costs associated with using the hardware accelerator (e.g., startup, teardown). Thus, the hardware accelerator may not be used by default when available. Instead, using the hardware accelerator may only be beneficial when the input data size is sufficiently large such that the benefits of using the hardware accelerator outweigh the costs.

### SUMMARY

Embodiments include a method of dynamically determining the applicability of a hardware accelerator to a request for a function, the request including a set of blocks of input data, a system, and a computer program product. The method includes storing a decision of whether to use the hardware accelerator or a software module to execute the function based on a previously processed request; determining whether the request matches the previously processed request; and processing the set of blocks of input data using the hardware accelerator or the software module according to the decision based on the request matching the previously processed request.

### BRIEF DESCRIPTION OF THE DRAWINGS

FIG. 1 is a block diagram of a system that performs dynamic determination of the applicability of a hardware accelerator to a request according to embodiments;

FIG. 2 is a process flow of a method of dynamically determining the applicability of a hardware accelerator to a request according to embodiments; and

FIG. 3 details the information collection process shown in FIG. 2.

### DETAILED DESCRIPTION

As noted above, when a hardware accelerator is available to execute a request, the decision of whether or not to use the hardware accelerator may be based on the size of the input data associated with the request. Specifically, if the input data is not sufficiently large, there may be little or no benefit to using the hardware accelerator rather than performing the task in software. A threshold may be established such that the hardware accelerator is used only when the input data size exceeds the threshold. When a set of input data blocks of different sizes must be processed together, mixed use of the hardware accelerator and software is not permitted by the hardware accelerator. Yet, using the size of the first block to determine whether to use a hardware accelerator or perform the task in software may lead to inefficiencies. This is because the size of the first block may not be representative of some or all of the remaining blocks and, thus, may not be determinative of the overall benefit or drawback of using a hardware accelerator. Another issue, specific to JAVA™, is that 64 byte buffers are used internally as a default. This means that, regardless of the actual size of the first block of a multi-block input data set, the buffer size is sufficiently small to force the use of software. Embodiments of the systems and methods detailed herein relate to collecting information related to multi-block requests, establishing a pattern recognition procedure, adjusting buffer size based on recognizing a pattern in the case of a JAVA™ application, and forcing a choice of software or a hardware accelerator, as needed, based on recognizing a pattern. These embodiments are detailed below.

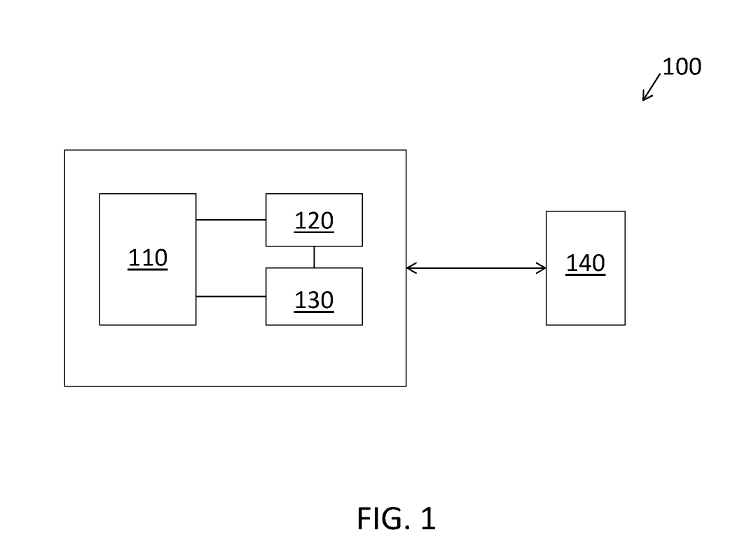

FIG. 1 is a block diagram of a system 100 that performs dynamic determination of the applicability of a hardware accelerator 140 to a request according to embodiments. The request is a processing request for a function such as compression, decompression, sorting, or searching, that may be implemented in software or hardware. The system 100 includes one or more processors 110 that process instructions stored in one or more memory devices 120. An interface 130 facilitates input and output of data to/from the memory device 120 or processor 110. According to embodiments detailed herein, the processor 110 may perform certain functions (e.g., compression, sorting) using a hardware accelerator 140 rather than a software module (instructions stored in the memory device 120 for processing by the processor 110 itself). The hardware accelerator 140 imposes overhead cost but may ultimately improve performance by offloading the execution of the requested function from the processor 110.

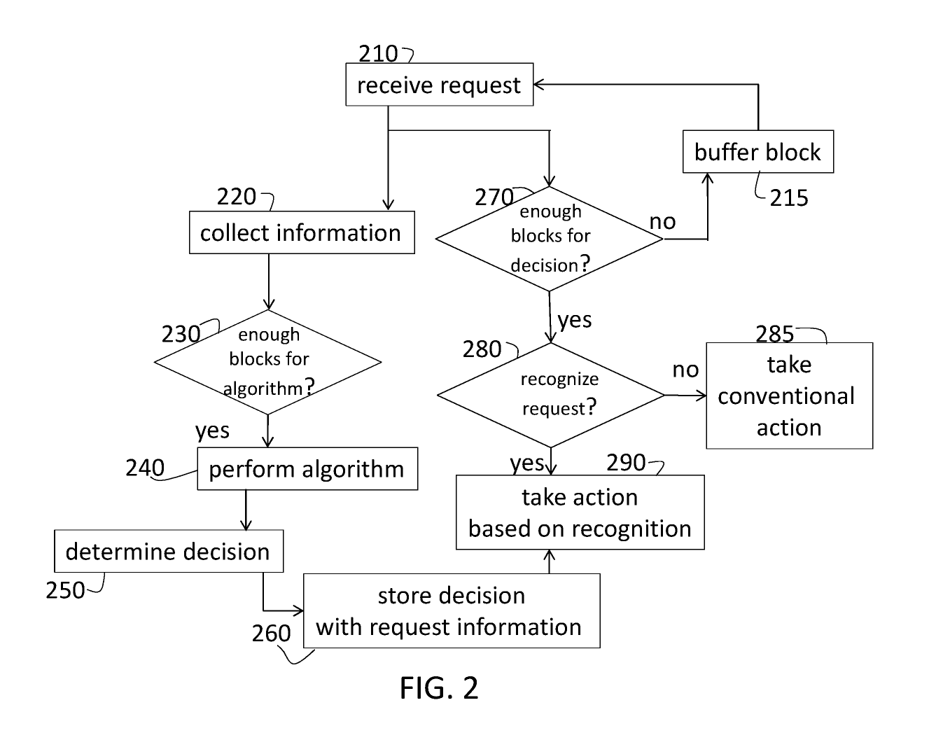

FIG. 2 is a process flow of a method of dynamically determining the applicability of a hardware accelerator 140 to a request according to embodiments. The processes shown in FIG. 2 are performed by the processor 110. When a JAVA™ application is being run by the processor 110, the JAVA™ layer replicates the processes shown in FIG. 2. That is, because the processes shown in FIG. 2 cannot be shared between the JAVA™ application and the underlying processor 110, the processes must be replicated in the JAVA™ layer and in the (lower) processor 110 layer. The JAVA™ application performs the processes in order to determine whether or not to manually adjust buffer sizes, as detailed with reference to processing blocks 260 and 290. The lower level (the processor 110) performs the processes in order to determine whether or not to force the use of software or the hardware accelerator 140 despite what the conventional decision might be (based on a size of the first block in the set of blocks of data input with the request).

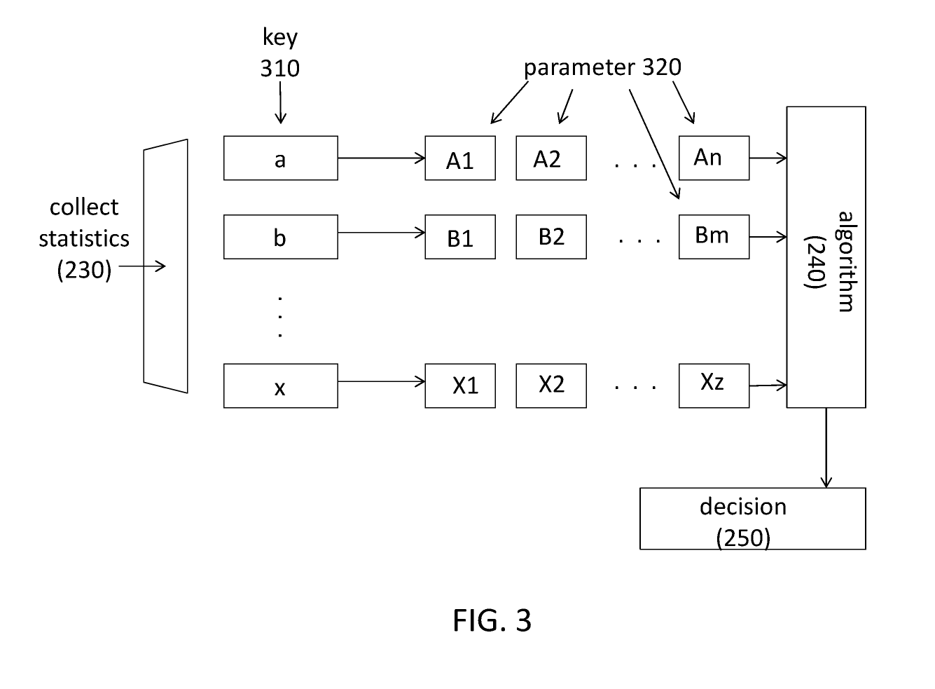

At process block 210, the processes include receiving a request with a set of blocks. At block 220, collecting information is performed as detailed with reference to FIG. 3. At block 230, checking whether enough blocks have been received to proceed refers to ensuring that the number of blocks needed for the algorithm (at block 240) have been received before proceeding to block 240. The number of blocks deemed to be enough may be the same in all cases. In alternate embodiments, the number of blocks of data needed to proceed to block 240 may be different based on the source of the request or other criteria (e.g., size of the first block). At processing block 240, performing an algorithm, which is also detailed with reference to FIG. 3, facilitates determining a decision, at processing block 250. Because the processes shown in FIG. 2 are run by the JAVA™ application (implemented by the processor 110) as well as the lower level processor 110, examples of the decision determined at block 250 include a decision to change the buffer size (used by the JAVA™ application) and a decision to select the hardware accelerator 140 regardless of the first block size. Storing this decision in association with the request (the collected information regarding request source and the size of the first block of the request, for example), at processing block 260, facilitates pattern recognition. As FIG. 2 indicates, the processes of collecting information (at 220) through determining a decision (at 250) are performed even for a recognized pattern (i.e., even when the collected information is identical or nearly identical to previously collected information). Accordingly, the process of storing the decision and request information (at 260) may over-write rather than additionally store information, based on a specified similarity in the collected information, to avoid storing multiple identical sets of data. The decision is stored in one or more of the memory devices 120 of the system 100. Accordingly, when the request is recognized (at processing block 280), taking action based on the decision (stored at processing block 260), at processing block 290, is facilitated.

When a request is received (block 210), the request is also checked for recognition, as described below. At block 270, it is determined if enough blocks have been received to facilitate the recognition. According to one embodiment, the first block may be sufficient. In alternate embodiments, blocks may be buffered (215) until enough blocks have been received to facilitate recognition. At process block 280, checking to see if the request is recognized includes considering both the source of the request, described with reference to FIG. 3 as a key 310, and the size of the first block (when recognition is based on just one block) or the pattern of sizes of the set of blocks. When the request is recognized (at block 280), the conventional process (e.g., checking the size of the first block) for making a decision of whether to use software or a hardware accelerator 140 may be overridden in lieu of processing block 290. At block 290, taking action based on the recognition (determined at block 280) may include, for example, using the hardware accelerator 140 even though the size of the first block is sufficiently small to suggest processing with software. When the request is not recognized (at block 280), taking conventional action includes selecting the hardware accelerator 140 or software based only on the size of the first block, for example. As FIG. 2 shows, even a recognized request is processed according to blocks 220 through 260. Thus, even if a request has previously been processed according to the processes of FIG. 2, any update in the decision (e.g., based on a change in the request from a given source) is captured.

FIG. 3 details the information collection process shown in FIG. 2. The process (220) is associated with a request involving a set of blocks of data. The set of blocks of data are first organized by a key 310. The key 310 may be an address space within the set of instructions being processed by the processor 110 or a task number or the like, which indicates an origin of the request within the instructions giving rise to the request. In addition to the key 310, information about the set of blocks of data provided with the request also includes some parameter 320 associated with each block of data in the request set. The parameter 320 may be block size such that, for example, A1, A2, . . . An indicate the sizes of the first n blocks of data in the request associated with key 310a. As FIG. 3 indicates, the same number of parameters 320 need not be collected for each request (each set of blocks of data) associated with each key 310. That is, for the set of data blocks associated with key 310b, parameters 320 B1, B2, . . . Bm are collected, and m may be a different number than n.

Once the information (key 310 and associated parameters 320) is collected for a given request, the algorithm (processing block 240) is executed. As noted above, the processes shown in FIG. 2 are performed by both the processor 110 and a JAVA™ application implemented by the processor 110. As also noted above, the decision (at processor block 250) is different based on which layer is running the processes. This is because the (lower level) processor 110 makes a decision as to whether software or a hardware accelerator 140 should be used, but the JAVA™ application makes a decision as to whether the default buffer size should be increased or not. As indicated in FIG. 2, once a decision has been stored (at processing block 260), when the similar request (e.g., compression, decompression, sorting) is generated again based on the set of instructions being executed by the processor 110 (with or without a JAVA™ application layer involved), the request is recognized (at processing block 280). The recognition is based on the key 310 (origin of the request) and additionally on the size of the first block or on the sizes of the first two or three blocks, for example. That is, the pattern of a small (e.g., 64 bytes) first block followed by large (e.g., 1 MB) second and third blocks may match with a request for which the statistics were previously processed (processing blocks 220-260). In this case, the decision stored at processing block 260 may be used (at processing block 290). For a given key 310, more than one pattern may be stored. That is, a pattern of blocks in a request from a given source are not overwritten if they are not the same (or similar enough, according to predefined thresholds) as a previously stored pattern of blocks.

The algorithm (processing block 240) is not limited by the examples discussed for explanatory purposes below, and the particular algorithm used may be based on the type of request (e.g., compression, decompression, sorting). In the exemplary case of parameters 320 A1 through An being block sizes for n blocks of the set of blocks of data associated with key 310a, the algorithm may perform a calculation on the parameter 320 values and determine if the result of the calculation is higher than a threshold size value used to determine whether a hardware accelerator 140 or software should be used. For example, the algorithm may obtain an average block size for the set of n blocks. The threshold size value may be the same threshold size value used to determine whether a request with a single input block should be processed by the hardware accelerator 140 or with software. Based on the outcome of the comparison of the average with the threshold size, the decision (at processing block 250) could be stored (at processing block 260) in conjunction with the request information (key 310 and parameters 320). In the case of a JAVA™ layer implementing the processes shown in FIG. 2, the decision (at block 250) would not be whether to use software or the hardware accelerator 140 but, instead, whether or not to increase the buffer size. The decision may be to increase the buffer size for all blocks of the set of blocks of data associated with the request from 64 bytes to 1 megabyte (MB), for example, based on the largest among the parameters 320 being 1 MB. The algorithm may drop the lowest and highest block sizes before obtaining an average. In the case of the hardware accelerator 140 performing decompression, the algorithm may count a number of blocks among the n blocks that are large enough (i.e., exceed a specified threshold size) to be eligible for the hardware accelerator 140. The ratio of eligible to ineligible blocks may be determined and used to determine the decision.

As noted above, when a JAVA™ application is being implemented, the processes shown in FIG. 2 are executed twice. At the application 110 level and at the JAVA™ application level (which is also processed by the processor 110), actions are taken (at processing block 290) based on the decision stored (at processing block 260) for a request that is recognized (at processing block 280). As an example, a recognized request is a request for compression of a 10 MB data file, and the 10 MB data file is provided as a set of blocks such that the first block of 64 bytes is followed by blocks of 1 MB. If this example were not implemented as a JAVA™ application, the processor 110 might override the decision to use software for the compression (based on the relatively small size of the first block) and instead use a hardware accelerator 140 for the compression of the 10 MB file. If this example were implemented as a JAVA™ application, the JAVA™ layer may first resize the buffers to be 1 MB for all the blocks associated with the recognized request and then the processor 100 might override a decision to use software and use a hardware accelerator 140 for compression instead. The adjustment of the buffer size alone improves performance, but the additional combination with the override of the decision, as needed, further improves performance and throughput. While compression and the override to use the hardware accelerator 140 when the first block of a set of blocks may indicate the use of software is specifically discussed herein, the embodiments are equally applicable to overriding the selection of a hardware accelerator 140 to use software instead (e.g., when the first block of a set of blocks associated with a request is relatively much larger).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of dynamically determining an applicability of a hardware accelerator to a request for a function, the request including a set of blocks of input data, the method comprising:
storing a decision of whether to use the hardware accelerator or a software module to execute the function based on a previously processed request;
determining, using a processor, whether the request matches the previously processed request; and
processing the set of blocks of input data using the hardware accelerator or the software module according to the decision based on the request matching the previously processed request.

2. The computer-implemented method according to claim 1, wherein the storing the decision includes storing the decision in association with a key and parameters associated with the previously processed request, the key indicating an origin of the previously processed request.

3. The computer-implemented method according to claim 2, wherein the determining whether the request matches the previously processed request includes determining whether the key matches an origin of the request.

4. The computer-implemented method according to claim 2, wherein the storing the decision includes executing an algorithm on the parameters associated with the previously processed request.

5. The computer-implemented method according to claim 4, wherein the executing the algorithm includes performing a calculation on the parameters, each of the parameters indicating a size of each of a number of blocks of input data associated with the previously processed request, and comparing the result with a threshold value.

6. The computer-implemented method according to claim 4, wherein the executing the algorithm includes obtaining a ratio of a number of parameters that exceed a threshold to a number of parameters that do not exceed the threshold, each of the parameters indicating a size of each of a number of blocks of input data associated with the previously processed request, and determining the decision is based on the ratio.

7. The computer-implemented method according to claim 1, further comprising storing a decision of whether to modify a buffer size for the set of blocks of input data based on the previously processed request in a JAVA™ application that generates the previously processed request and the request.

8. The computer-implemented method according to claim 7, further comprising determining, in the JAVA™ application, whether the request matches the previously processed request and modifying the buffer size based on the request matching the previously processed request.
